(19) United States
(12) Patent Application Publication
(10) Pub. No.: US 2026/0371317 A1
(43) Pub. Date: Nov. 19, 2026

(54) SYSTEM AND METHOD FOR SHARING CELLS WITH SELECTIVE UPLINK SUMMING

(71) Applicant: JOHN MEZZALINGUA ASSOCIATES, LLC., Liverpool, NY (US)

(72) Inventors: Massimo NOTARGIACOMO, Castel Bolognese (IT); Vincenzo ICOLARI, Forli (IT); Alessandro PAGANI, San Giovanni (IT)

(21) Appl. No.: 19/142,829

(22) PCT Filed: Oct. 18, 2024
(86) PCT No.: PCT/US2024/051895

§ 371 Date: Jun. 24, 2025

Related U.S. Application Data
(60) Provisional application No. 63/591,677, filed on Oct. 19, 2023.

(51) Int. Cl. H04W 72/044; H04W 72/542

(52) U.S. Cl. CPC H04W 72/044; H04W 72/542

(57) ABSTRACT

A 5G Radio Access Network has a DU (Distributed Unit) and a plurality of RUs (Remote Units) that are coupled to the DU over an ethernet network. A method for operating Radio Access Network comprises instantiating a plurality of fronthaul receivers; coupling each of the plurality of fronthaul receivers to one or more designated remote units; receiving, by each of the plurality of fronthaul receivers, a plurality of data packets from its designated one or more remote units; processing the plurality of packets to generate a plurality of resource grids, each of the plurality of resource grids having samples from one of the one or more remote units; and selectively summing a plurality of samples within a corresponding resource block of a plurality of resource grids, wherein each of the corresponding resource blocks have samples indicating a signal strength above a threshold.

### BACKGROUND OF THE INVENTION

Conventional 5G NR (New Radio) RAN (Radio Access Network) systems may involve a Central Unit (CU), a Distributed Unit (DU) coupled to the CU, and a plurality of Remote Units (RUS). The multiple RUs may all share a single cell whereby each of the RUs use the same carrier frequencies and some of the RUs may cover overlapping areas.

Such RANs may broadcast a single signal in the Downlink (DL) such that all the RUs receive the same signal from the DU and broadcast it accordingly. However, for the Uplink (UL), each RU may not receive the same signals from its connected User Equipment (UEs) because the RUs may have non-overlapping coverage areas and may have different channel conditions. Accordingly, even though a single signal is broadcast by all of the RUs for the Downlink, each RU may receive a unique signal in the uplink per spatial stream. Under conventional operation, the signals from all of the RUs in this shared cell coverage area are summed. In doing so, the DU receives a single signal in the uplink, which is the summation of all of the RUs sharing the cell.

Conventional uniform uplink summing has certain deficiencies. For example, summing the signal from every RU sums the noise from each of the RUs, degrading the signal to noise ratio with each additional RU signal summed. For example, a given RU may receive a strong signal from one or more UEs that have very weak signal reception in the other RUs. In doing uniform summing, the summed uplink signal from these one or more UEs has a worse signal quality compared to the signal received by the single RU. Further, if the uplink signals from all of the RUs are being summed, there is no opportunity for two different UEs to share the same uplink resources in the spatial dimension, i.e., considering the uplink signals as independent paths, thereby limiting the number of UEs whose uplink signals can be processed. These issues are not limited to 5G and are problematic in other RAN technologies (e.g., 4G) as well.

Accordingly, what is needed is a RAN, such as a 5G RAN, that provides selective summing of UL signals from its RUs for maximum gain, extended coverage area, and minimal signal degradation as well as enabling multiple UEs to share the same uplink resources.

### SUMMARY OF THE INVENTION

An aspect of the disclosure involves a method for operating a radio access network having a baseband processor and a plurality of remote units. The method comprises instantiating a plurality of fronthaul receivers; coupling each of the plurality of fronthaul receivers to one or more designated remote units; receiving, by each of the plurality of fronthaul receivers, a plurality of data packets from its designated one or more remote units; processing the plurality of packets to generate a plurality of resource grids, each of the plurality of resource grids having samples from one of the one or more remote units; and selectively summing a plurality of samples within a corresponding resource block of a plurality of resource grids, wherein each of the corresponding resource blocks have samples indicating a signal strength above a threshold.

Another aspect of the disclosure involves a non-transitory memory encoded with machine readable instructions which, when executed by one or more processors, implements a process for operating a radio access network having a baseband processor and a plurality of remote units. The process comprises instantiating a plurality of fronthaul receivers; coupling each of the plurality of fronthaul receivers to one or more designated remote units; receiving, by each of the plurality of fronthaul receivers, a plurality of data packets from its designated one or more remote units; processing the plurality of packets to generate a plurality of resource grids, each of the plurality of resource grids having samples from one of the one or more remote units; and selectively summing a plurality of samples within a corresponding resource block of a plurality of resource grids, wherein each of the corresponding resource blocks have samples indicating a signal strength above a threshold.

### BRIEF DESCRIPTION OF DRAWINGS

FIG. 1 illustrates an exemplary RAN according to the disclosure, showing logical connections between RUs and their DU receivers.

FIG. 2 illustrates an exemplary RAN according to the disclosure, showing logical connections between the RUs and their DU receivers, wherein the receivers perform designated summing.

FIG. 3 illustrates an exemplary RAN, illustrating physical connections whereby the RAN of FIG. 3 may be used to implement the logical connection topologies of FIGS. 1 and 2.

### DETAILED DESCRIPTION OF THE INVENTION

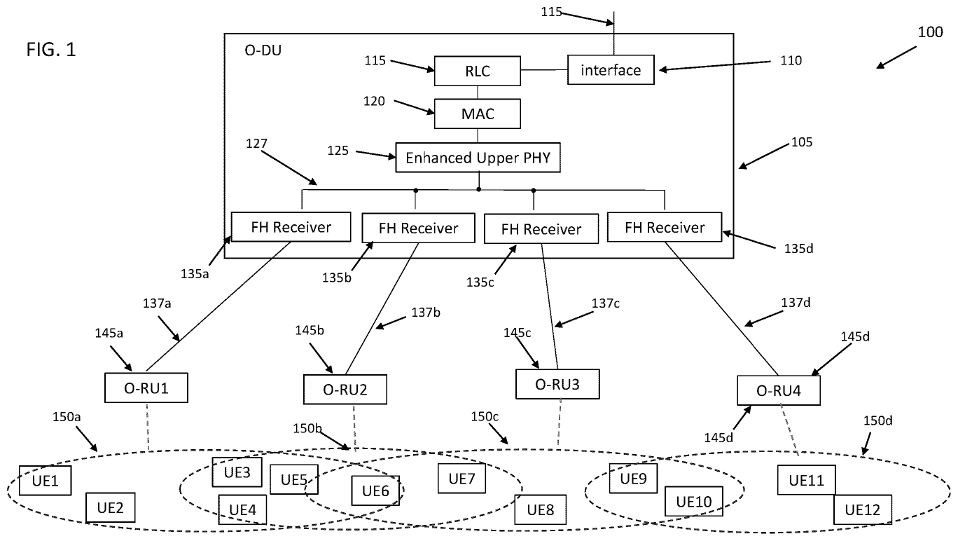

FIG. 1 illustrates an exemplary RAN configuration 100 according to the disclosure. Exemplary RAN configuration 100 is depicted as a 5G NR (New Radio) implementation according to the O-RAN (Open-RAN) specification, showing logical connections. RAN configuration 100 has an O-DU (O-RAN Distributed Unit) 105 that may be coupled to an O-CU (O-RAN Centralized Unit—not shown) over an F1 interface 115. O-DU 105 may have a network interface module 110 that couples the F1 interface 115 to a 5G protocol stack segment having an RLC (Radio Link Control) layer module 115; a MAC (Medium Access Control) layer module 120; and an Enhanced Upper PHY (Physical) layer module 125. The functions of RLC layer 115, MAC scheduler 120 may provide an implementation of the O-DU and 5G specifications. Enhanced Upper PHY module 125 may implement upper physical layer processing according to the O-DU and 5G specifications.

Enhanced Upper PHY layer 125 also performs additional functionality according to the disclosure that is described below. Enhanced Upper PHY module 125 may be connected to a fronthaul receiver 135a, fronthaul receiver 135b, fronthaul receiver 135c, and fronthaul receiver 135d over an internal bus 127. The function of the fronthaul receivers 135a-d is described below.

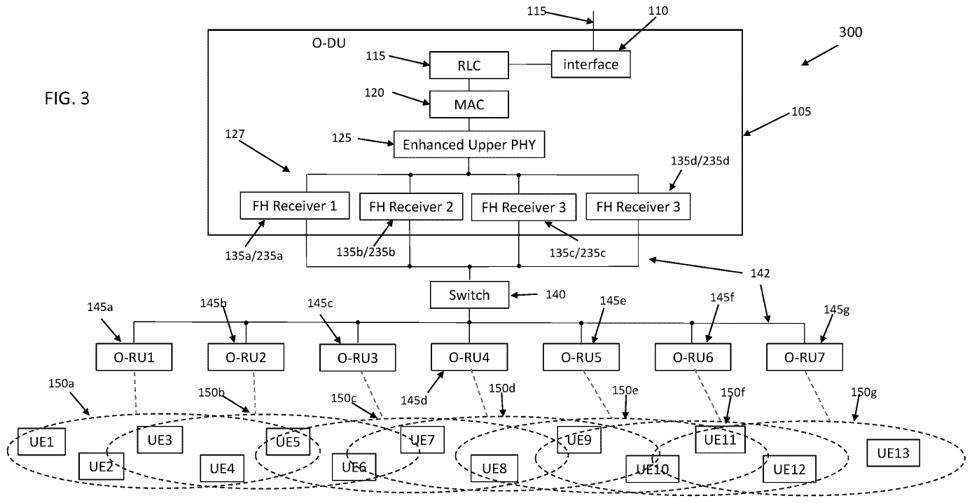

Fronthaul receiver 135a may be coupled to O-RU1 145a over a logical connection 137a; Fronthaul receiver 135b may be coupled to O-RU1 145b over a logical connection 137b; Fronthaul receiver 135c may be coupled to O-RU1 145c over a logical connection 137c; and Fronthaul receiver 135d may be coupled to O-RU1 145d over a logical connection 137d. Each of the logical connections 137a-d may be implemented over physical connections illustrated in FIG. 3 and described below. The use of logical connections 137a-d are for illustrative purposes and intended to show the topology of connections between fronthaul receivers 135a-d and O-RUs 145a-d.

Fronthaul receiver 135a, fronthaul receiver 135b, fronthaul receiver 135c, and fronthaul receiver 135d may be collectively referred to as specific implementations of a fronthaul receiver 135. Although four fronthaul receivers 135 are illustrated and discussed in this example, it will be understood that more or fewer fronthaul receivers 135 are possible and within the scope of the disclosure. Similarly, O-RU1 145a, O-RU2 145b, O-RU3 145c, and O-RU4 145d may be referred to as a specific instance of an O-RU 145. Although four O-RUs 145 are illustrated in FIG. 1, it will be understood that more of fewer O-RUs 145 are possible and within the scope of the disclosure.

Each of fronthaul receivers 135 may include one or more software modules that does the following: receive packetized 7.2× data from the O-RU 145 to which it is coupled; depacketize the received 7.2× data; decompress the depacketized data if data compression is enabled; convert the decompressed depacketized data from integer format to floating point format into I/Q (In-phase/Quadrature) samples; and reconstruct a resource grid of I/Q samples for subsequent processing by Enhanced Upper PHY module 125.

RAN configuration 100 includes an O-RU1 145a, an O-RU2 145b, an O-RU3 145c, and an O-RU4 145d. Each of the O-RUs 145 may have one or more processors and software modules (not shown) for implementing Lower PHY layer functionality defined by the O-RAN and 5G specifications. Each O-RU 145 may also have the necessary radio components and antennas to transmit and receive RF (Radio Frequency) signals over the air.

As illustrated, O-RU1 145a has a cell coverage area 150a; O-RU2 145b has a cell coverage area 150b; O-RU3 145c has a cell coverage area 150c; and O-RU4 145d has a cell coverage area 150d. All of the O-RUs 145 and their cell coverage areas 150 may correspond to the same cell, meaning that the O-RUs 145 are transmitting and receiving on the same carrier frequencies.

As illustrated, cell coverage areas 150 may have overlapping and non-overlapping components. For example, cell coverage area 150a of O-RU1 145a has connection with UE1, UE2, UE3, UE4, UE5, and UE6, whereby it has exclusive connection with UE1 and UE2; and O-RU1 145a also shares connection to UE3, UE4, UE5, and UE6 with O-RU2 145b via its cell coverage area 150b. Further, as illustrated, some cell coverage areas 150 have no overlap, such as cell coverage area 150b of O-RU2 145b and cell coverage area 150d of O-RU4 145d. In this case, O-RU2 145b and O-RU4 145d are connected to distinct sets of UEs (UE3/UE4/UE5/UE6/UE7 and UE9/UE10/UE11/UE12, respectively).

All of the component modules (for example, interface 110, RLC layer module 115, MAC scheduler module 120, Enhanced Upper PHY layer module 125, fronthaul receiver 135a, fronthaul receiver 135b, fronthaul receiver 135c, fronthaul receiver 135d, and the Lower PHY layer modules of the O-RUs 145)—and the use of the term “module” herein—may refer to a set of machine readable instructions that are encoded within one or more non-transitory memory devices and executed on one or more processors that host O-DU 105 and O-RUs 145. As used herein, the term “non-transitory memory” may refer to any tangible storage medium (as opposed to an electromagnetic or optical signal) and refer to the medium itself, and not to a limitation on data storage (e.g., RAM vs. ROM). For example, non-transitory medium may refer to an embedded memory that is encoded with instructions whereby the memory may have to be re-loaded with the appropriate machine-readable instructions after being power cycled. Each of the modules disclosed herein may be hosted on one or more processors within O-DU 105 and each of the O-RUs 145. It will be understood that variations to the how these modules are deployed on a hardware compute environment are possible and within the scope of the disclosure.

Further, if an action is described herein as being done by a referenced module (e.g., “e.g., a fronthaul receiver 135 sums the signals . . . ”) it will be understood that this may describe one or more processors executing the module's machine-readable instructions to perform the particular action.

Also, as used herein, “uplink resources” may refer to a given set of resource blocks within a resource grid and over one spatial dimension. Further, a single UE may be allocated one or more resource blocks. A resource block may have multiple I/Q samples. For example, in 4G a resource block has 12 subcarriers times the number of 14 OFDM symbols, whereas in 5G a resource block has 12 subcarriers regardless the number of OFDM symbols.

Exemplary RAN configuration 100 may operate as follows. In the Uplink, each O-RU 145 receives signals from UEs within its coverage area. Each of the O-RUs 145 perform RF (Radio Frequency) reception and lower PHY processing to generate packetized 7.2× data encapsulating digitized samples of the baseband signal received by each UE. For exemplary RAN configuration 100, O-RU1 145a receives and does lower PHY processing on uplink signals from UE1, UE2, UE3, UE4, UE5, and UE6, converts the signals into packetized 7.2× data, and transmits the packetized 7.2× data to fronthaul receiver 135a over logical connection 137a; O-RU2 145b receives and does lower PHY processing on uplink signals from UE3, UE4, UE5, UE6, and UE7, converts the signals into packetized 7.2× data, and transmits the packetized 7.2× data to fronthaul receiver 135b over logical connection 137b; O-RU3 145c receives and does lower PHY processing on uplink signals from UE6, UE7, UE8, UE9, and UE10, converts the signals into packetized 7.2× data, and transmits the packetized 7.2× data to fronthaul receiver 135c over logical connection 137c; and O-RU4 145d receives and does lower PHY processing on uplink signals from UE9, UE10, UE11, and UE12, converts the signals into packetized 7.2× data, and transmits the packetized 7.2× data to fronthaul receiver 135d over logical connection 137d.

Fronthaul receiver 135a receives the 7.2× data from O-RU1 145a , depacketizes the received 7.2× data; decompresses the depacketized data (if data compression is enabled_; converts the decompressed depacketized data from integer format to floating point format into I/Q (In-phase/Quadrature) samples; and reconstructs a resource grid of I/Q samples. Here the reconstructed resource grid has resource blocks with I/Q sample data from UE1, UE2, UE3, UE4, UE5, and UE6. Fronthaul receiver 135b receives the 7.2× data from O-RU2 145b , depacketizes the received 7.2× data; decompresses the depacketized data if data compression is enabled; converts the decompressed depacketized data from integer format to floating point format into I/Q (In-phase/Quadrature) samples; and reconstructs a resource grid of I/Q samples. Here the reconstructed resource grid has resource blocks with I/Q sample data from UE3, UE4, UE5, UE6, and UE7. Fronthaul receiver 135c receives the 7.2× data from O-RU3 145c , depacketizes the received 7.2× data; decompresses the depacketized data if data compression is enabled; converts the decompressed depacketized data from integer format to floating point format into I/Q (In-phase/Quadrature) samples; and reconstructs a resource grid of I/Q samples. Here the reconstructed resource grid has resource blocks with I/Q sample data from UE6, UE7, UE8, UE9, and UE10. Fronthaul receiver 135d receives the 7.2× data from O-RU4 145d , depacketizes the received 7.2× data; decompresses the depacketized data if data compression is enabled; converts the decompressed depacketized data from integer format to floating point format into I/Q (In-phase/Quadrature) samples; and reconstructs a resource grid of I/Q samples. Here the reconstructed resource grid has resource blocks with I/Q sample data from UE9, UE10, UE11, and UE12.

The resource grids generated by fronthaul receiver 135a and fronthaul receiver 135b both have I/Q samples from UE3, UE4, UE5, and UE6; and the resource grid generated by fronthaul receiver 135a exclusively has I/Q samples from UE1 and UE2. The resource grids generated by fronthaul receiver 135b and fronthaul receiver 135c both have I/Q samples from UE6 and UE7; and the resource grid generated by fronthaul receiver 135c exclusively has I/Q samples from UE8. The resource grids generated by fronthaul receiver 135c and fronthaul receiver 135d both have I/Q samples from UE9 and UE10; and the resource grid generated by fronthaul receiver 135d exclusively has I/Q samples from UE11 and UE12.

Accordingly, I/Q samples from UE1 and UE2 are exclusively present in the resource grid of fronthaul receiver 135a; I/Q samples from UE3, UE4, UE5, and UE6 are present in the resource grids of fronthaul receiver 135a and fronthaul receiver 135b; I/Q samples from UE6 are present in the resource grids of fronthaul receiver 135a, fronthaul receiver 135b, and fronthaul receiver 135c; I/Q samples from UE7 are present in the resource grids of fronthaul receiver 135b and fronthaul receiver 135c; I/Q samples from UE8 are exclusively present in the resource grid of fronthaul receiver 135c; the I/Q samples of UE9 and UE10 are present in the resource grids of fronthaul receiver 135c and fronthaul receiver 135d; and the I/Q samples of UE11 and UE12 are exclusively in the resource grid of fronthaul receiver 135d.

The fronthaul receivers 135 generate a respective resource grid once every TTI (Transmission Time Interval).

The fronthaul receivers 135 transmit their respective resource grids to the Enhanced Upper PHY module 125 over internal bus 127.

Enhanced Upper PHY module 125 processes the resource grids from fronthaul receivers 135 as follows. First, it computes a SINR (Signal to Interference and Noise Ratio) for each of the resource blocks on a UE basis within each of the received resource grids. It may then disregard any resource blocks that have a SINR below a pre-configured threshold. With this done, the Enhanced Upper PHY module 125 identifies which resource grids share UE samples and which have UE samples exclusively to it (e.g., UE1/UE2 for fronthaul receiver1 135a and UE11/12 for fronthaul receiver4 135d). For those resource grids that share I/Q samples from given UEs, Enhanced Upper PHY processor 125 may perform weighted summing whereby it executes instructions to perform weighted summing or equalization whereby it multiplies the received signal by a weight, based on the estimated SINR, that maximizes the likelihood of the transmitted signal given the received one, and do so across conjugate resource blocks of those resource grids. For example, Enhanced Upper PHY module 125 adds weighted I/Q samples for the resource blocks allocated to UE6 across the resource grids from fronthaul receiver 135a, fronthaul receiver 135b, and fronthaul receiver 135c (and not from fronthaul receiver 135d).

Similarly, Enhanced Upper PHY module 125 adds weighted I/Q samples for the resource blocks allocated to UE9 and UE10 across the resource grids from fronthaul receiver 135c and fronthaul receiver 135d (and not from fronthaul receiver 135a or fronthaul receiver 135b). In doing so, by implementing selective weighted summing, resource blocks having weak signal are discarded and do not contribute noise to the summation.

Enhanced Upper PHY module 125 also may identify resource blocks from UEs that are exclusive to individual fronthaul receivers 135. Examples include UE1 from fronthaul receiver 135a and UE11 from fronthaul receiver 135d. Given that they are exclusively within the coverage area of O-RU1 145a and O-RU4 145d, respectively, Enhanced Upper PHY module 125 may transmit this information to MAC scheduler 120. In this case, MAC scheduler 120 may allocate the same resource blocks to UE1 for O-RU1 145a and to UE11 for O-RU4 145d. The same may be done for UE2 and UE12. In doing so, Enhanced Upper PHY module 125 enables Multi-user MIMO (Multiple Input Multiple Output) for RAN configuration 100.

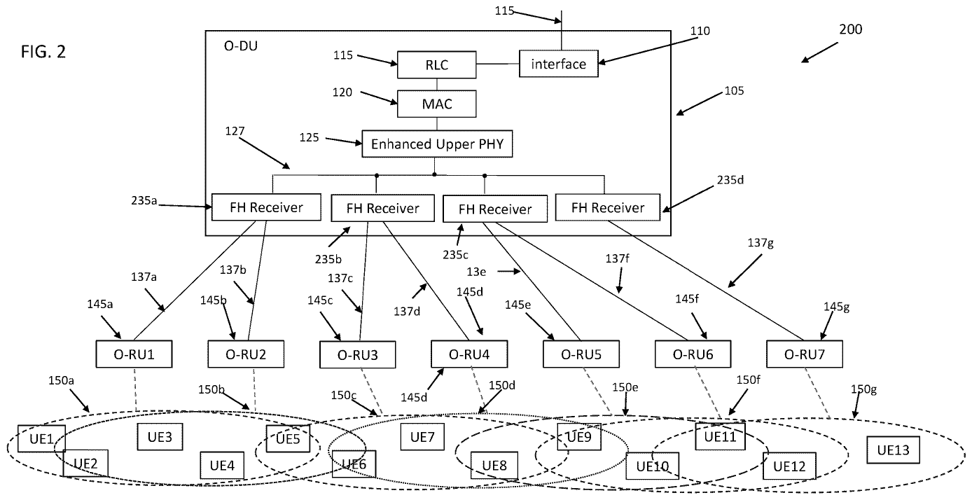

FIG. 2 illustrates an exemplary RAN configuration 200 in which several fronthaul receivers 235 perform summing. Exemplary RAN configuration 200 has seven O-RUs 145 having differing degrees of overlap among their respective coverage areas 150. The O-RUs 145 are coupled to designated fronthaul receivers 235, illustrated as logical connections 137. As illustrated, fronthaul receiver 235a receives 7.2× uplink data from O-RU1 145a and O-RU2 145b; fronthaul receiver 235b receives 7.2× uplink data from O-RU3 145c and O-RU4 145d; and fronthaul receiver 235c receives 7.2× uplink data from O-RU5 145e and O-RU6 145f. Fronthaul receivers 235 may perform the same functions as fronthaul receivers 135 but performs the steps in parallel on the multiple 7.2× data sets received from its coupled O-RUs 145. In this case, fronthaul receivers 235 may generate multiple resource grids, one corresponding to each O-RU 145 coupled to it. Fronthaul receivers 235 may then perform an additional step of summing the corresponding I/Q samples across the multiple resource grids generated by that fronthaul receiver 235. In this example, fronthaul receiver 235a may sum the corresponding resource blocks from the resource grids it respectively generates from O-RU1 145a and O-RU2 145b; fronthaul receiver 235b may sum the corresponding resource blocks from the resource grids it respectively generates from O-RU3 145c and O-RU4 145d; and fronthaul receiver 235c may sum the corresponding resource blocks from the resource grids it respectively generates from O-RU5 145e and O-RU6 145f. Further to this example, fronthaul receiver 235d receives and processes 7.2× data from just O-RU7 145g.

Further to RAN configuration 200, Enhanced Upper PHY layer 125 may process the resource grids from fronthaul receivers 235a/b/c/d in a manner similar to the description above for RAN configuration 100.

Fronthaul receivers 235 may sum corresponding I/Q samples from different numbers or combinations of O-RUs 145, in variations from the illustrated RAN configuration 200. The designation of which O-RUs 145 get summed by fronthaul receivers 235 may be determined according to the extent of overlap of coverage areas 150. It will be understood that such variations are possible and within the scope of the disclosure.

FIG. 3 illustrates a RAN 300 that may form the basis of RAN configuration 100 and RAN configuration 200. Illustrated are the physical connections through which the logical connections 137 of FIGS. 1 and 2 may be implemented. As illustrated, O-RUs 145 and fronthaul receivers 135/235 may be coupled to an Ethernet network 142 using an eCPRI (enhanced Common Public Radio Interface) protocol, for example. Ethernet network 142 may include a switch 140 for routing uplink 7.2× packets (as defined in the O-RAN specification) from each O-RU 145 to its respective fronthaul receiver 135/235 according to-for example-RAN configurations 100 or 200. Accordingly, different O-RU 145 to fronthaul receiver 235 combinations may be achieved for summing.

The software modules corresponding to fronthaul receivers 135/235 and network switch 140 may be executed on processors integral to or remotely allocated to O-DU 105. In this case, network switch 140, and receivers 135 may by hosted on the same server boards RLC layer 115, MAC scheduler 120, and Upper PHY module 125.

Although FIGS. 1-3 illustrate a RAN with only a single cell, it will be understood that the disclosed RAN may involve multiple cells and different clusters of O-RUs 145. Each of these additional cells and O-RUs 145 may operate the same was as described above. Further, each O-RU 145 may have the capability of operating in multiple carrier frequencies and thus in multiple cells, and these cells may be handled in the same manner as described above. It will be understood that such variations are possible and within the scope of the disclosure.

Although exemplary RAN 100 is described above as an O-RAN (Open Ran) 5G implementation, it will be understood that the disclosure applies to other RAN technologies as well, such as a non-O-RAN implementation, or an LTE (Long Term Evolution) implementation. In the former case, O-DU 105 may be a 5G NR gNodeB DU. In the latter case, O-DU 105 may be an LTE eNodeB or other form of baseband processor. Although exemplary RAN 100 discloses the use of 7.2× data over packetized Ethernet network 142, it will be understood that non-7.2× eCPRI or other packet-based protocols may be used. Accordingly, the term “baseband processor” may apply to a 5G DU, a 5G gNodeB combination, or an eNodeB. In these variations, the protocol stack segment (modules 125, 120, and 115) may include a Lower PHY layer within the Upper PHY layer 125 to form a PHY layer, and may include upper protocol stack layers according to the given telecommunications standard. Further, each of the O-RUs 145 may be radio remote units that operate within a RAN using a different air interface technology, such as LTE. In another variation, packetized ethernet network 142 may be replaced with a CPRI fronthaul bus or custom fronthaul bus, as long as signals received by the RUs 145 are digitized and relayed along the fronthaul bus so that they may be reconstructed by the receivers 135. It will be understood that such variations are possible and within the scope of the disclosure.

1. A method for operating a radio access network having a baseband processor and a plurality of remote units, comprising:
instantiating a plurality of fronthaul receivers;
coupling each of the plurality of fronthaul receivers to one or more designated remote units;
receiving, by each of the plurality of fronthaul receivers, a plurality of data packets from its designated one or more remote units;
processing the plurality of data packets to generate a plurality of resource grids, each of the plurality of resource grids having data samples from a corresponding one of the one or more remote units; and
selectively summing a plurality of data samples within a corresponding resource block of a plurality of resource grids, wherein each corresponding resource block of the plurality of resource grids has data samples indicating a signal strength above a threshold.

2. A method of claim 1, wherein each corresponding resource block of the plurality of resource grids relates to a same UE in communication with each remote unit of the one or more remote units associated with each of the plurality of resource grids, respectively.

3. The method of claim 1, further comprising:
Identifying a first resource block having a first plurality of data samples corresponding to a first UE (User Equipment) exclusively in a first resource grid;
Identifying a second resource block having a second plurality of data samples corresponding to a second UE exclusively in a second resource grid; and
instructing a MAC (Medium Access Control) scheduler to allocate a single set of resource blocks for both the first UE and the second UE.

4. The method of claim 1, wherein the selective summing comprises:
computing a signal strength weighting factor for each of the data samples within the corresponding resource block in the plurality of resource grids;
identifying a set of resource grids within the plurality of resource grids having a corresponding plurality of resource blocks with data samples having its signal strength weighting factor above a threshold;
multiplying each of the data samples by its signal strength weighting factor;
summing the data samples across the set of resource grids to calculate a weighted summed sample.

5. The method of claim 4, wherein the signal strength weighting factor comprises a SINR (Signal to Interference and Noise Ratio).

6. The method of claim 1, wherein the data samples are I/Q (In-phase/Quadrature) samples.

7. The method of claim 1, wherein the processing the plurality of data packets comprises:
depacketizing each of the plurality of data packets to generate a plurality of data;
converting the plurality of data into a plurality of data samples; and
reconstructing a resource grid having the plurality of data samples.

8. The method of claim 7, wherein the converting the plurality of data into a plurality of data samples comprises converting an integer data into a floating point sample.

9. The method of claim 7, further comprising decompressing the plurality of data.

10. The method of claim 1, wherein each remote unit comprises an O-RU (O-RAN Remote Unit).

11. The method of claim 10, wherein the packetized data comprises 7-2× packetized data.

12. A non-transitory memory encoded with machine readable instructions which, when executed by one or more processors, implements a process for operating a radio access network having a baseband processor and a plurality of remote units, comprising:
instantiating a plurality of fronthaul receivers;
coupling each of the plurality of fronthaul receivers to one or more designated remote units;
receiving, by each of the plurality of fronthaul receivers, a plurality of data packets from its designated one or more remote units;
processing the plurality of data packets to generate a plurality of resource grids, each of the plurality of resource grids having data samples from a corresponding one of the one or more remote units; and
selectively summing a plurality of data samples within a corresponding resource block of a plurality of resource grids, wherein each of the corresponding resource blocks have data samples indicating a signal strength above a threshold.

13. The non-transitory memory of claim 12, wherein each corresponding resource block of the plurality of resource grids relates to a same UE in communication with each remote unit of the one or more remote units associated with each of the plurality of resource grids, respectively.

14. The non-transitory memory of claim 12, wherein the process further comprises:
identifying a first resource block having a first plurality of data samples corresponding to a first UE (User Equipment) exclusively in a first resource grid;
identifying a second resource block having a second plurality of data samples corresponding to a second UE exclusively in a second resource grid; and
instructing a MAC (Medium Access Control) scheduler to allocate a single set of resource blocks for both the first UE and the second UE.

15. The non-transitory memory of claim 12, wherein the selective summing comprises:
computing a signal strength weighting factor for each of the data samples within the corresponding resource block in the plurality of resource grids;
identifying a set of resource grids within the plurality of resource grids having a corresponding plurality of resource blocks with data samples having its signal strength weighting factor above a threshold;
multiplying each of the data samples by its signal strength weighting factor;
summing the data samples across the set of resource grids to calculate a weighted summed sample.

16. The non-transitory memory of claim 15, wherein the signal strength weighting factor comprises a SINR (Signal to Interference and Noise Ratio).

17. The non-transitory memory of claim 12, wherein the data samples are I/Q (In-phase/Quadrature) samples.

18. The non-transitory memory of claim 12, wherein the processing the plurality of data packets comprises:
depacketizing each of the plurality of data packets to generate a plurality of data;
converting the plurality of data into a plurality of data samples; and
reconstructing a resource grid having the plurality of data samples.

19. The non-transitory memory of claim 18, wherein the converting the plurality of data into a plurality of data samples comprises converting an integer data into a floating point sample.

20. The non-transitory memory of claim 18, further comprising decompressing the plurality of data.

21. The non-transitory memory of claim 12, wherein each remote unit comprises an O-RU (O-RAN Remote Unit).

22. The non-transitory memory of claim 21, wherein the packetized data comprises 7-2× packetized data.
